(19) United States
(12) Patent Application Publication
(10) Pub. No.: US 2002/0041269 A1
(43) Pub. Date: Apr. 11, 2002

(54) Information processing apparatus

(75) Inventor: Masanori Ryuuzaki, Yamagata (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/965,861

(22) Filed: Oct. 1, 2001

(30) Foreign Application Priority Data
Oct. 6, 2000 (JP) 307115/2000

(51) Int. Cl. G09G 5/00

(52) U.S. Cl. 345/156

(57) ABSTRACT

To provide an information processing apparatus capable of reflecting individuality of a user when viewed from the front thereof in an open state of a display unit, such as in a case of use, the information processing apparatus, which includes a base unit having a keyboard and a palm rest on an upper surface and a display unit coupled to the base unit to be opened and closed with respect to the base unit, includes a cover unit which covers at least a portion of the base unit to form the palm rest and being attachably and detachably mounted on the base unit.

### BACKGROUND OF THE INVENTION

The present invention relates to an information processing apparatus such as a notebook computer, which includes a base unit having a keyboard on a surface thereof and a display unit attached to the base unit, particularly to a notebook computer characterized by a palm rest on which a user lays a palm during operation of the keyboard.

In recent years, as a notebook computer is made smaller and thinner, opportunities of carrying the notebook computer for use have been increased. Therefore, in order to show individuality of a user, or not to mistake a notebook computer of the other person for that of the user, the user comes to be concerned with an exterior design of the notebook computer.

Japanese Utility Model Registration No. 3027116 discloses a following technology. According to the prior art, a transparent cover unit is attachably and detachably overlaid on an outside of a case of a base unit or a display unit of a notebook computer. Moreover, a sheet matter selected by the user in accordance with preference, such as a photograph, is held between the cover unit and the case, thus preventing the user from mistaking a notebook computer of the other person for that of the user.

An appearance of the outside case of the notebook computer is individualized by use of the prior art. The prior art can contribute to a distinction between the notebook computer of the user and that of the other person only in a closed state. of the display unit over the base unit of the notebook computer, such as in a case of carrying the notebook computer. However, it is difficult to say that the prior art contributes to the distinction between the notebook computer of the user and that of the other person when viewed from the front thereof in an open state of the display unit, such as in a case of use. In addition, the prior art is aimed at only individualization, while not providing any facility for the notebook computer itself.

### SUMMARY OF THE INVENTION

The object of the present invention is to provide an information processing apparatus, such as a notebook computer, capable of reflecting individuality of a user when viewed from the front thereof in an open state of a display unit, such as in a case of use.

According to the present invention, the information processing apparatus, which includes abase unit having a keyboard and a palm rest on an upper surface and a display unit coupled to the base unit to be opened and closed with respect to the base unit, includes a cover unit which covers at least a portion of the base unit to form the palm rest and being attachably and detachably mounted on the base unit.

### BRIEF DESCRIPTION OF THE DRAWINGS

These and other objects, features and advantages of the invention will become more apparent from the following detailed description when taken in conjunction with the accompanying drawings, in which:

FIG. 1 is a perspective view showing a state of attaching a cover unit to a notebook computer of the present invention;

FIG. 2 is a perspective view showing a state of detaching the cover unit from the notebook computer of the present invention;

FIG. 3 is a perspective view showing a state of detaching the cover unit from the notebook computer of the present invention;

FIG. 4 is a perspective view showing a state of attaching a cover unit to a notebook computer of the present invention; and

FIG. 5 is a perspective view showing a state of detaching the cover unit from the notebook computer of the present invention.

In the drawings, the same reference numerals represent the same structural elements.

### DESCRIPTION OF THE PREFERRED EMBODIMENTS

Embodiments of the present invention are specifically described in the following with reference to the attached drawings.

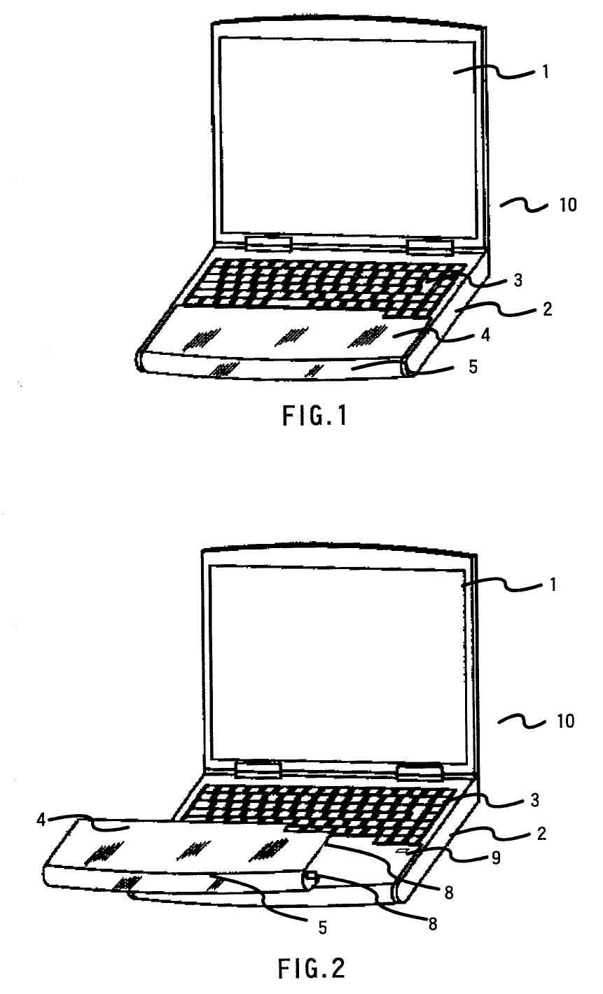

Referring to FIG. 1, a notebook computer 10 of a first embodiment according to the present invention includes a display unit 1 and a base unit 2 having a keyboard 3 on an upper surface thereof.

The display unit 1 is coupled to the base unit 2 with hinges so as to be opened and closed.

In the drawing, a palm rest 4, on which a user lays a palm during operation of the keyboard, is provided before the keyboard 3.

Referring to FIG. 2, a cover unit 5 is attachably and detachably mounted on the base unit 2 to cover a part of the upper surface and a part of the lower surface of the base unit 2 from the front thereof. The palm rest 4 is constituted of a part of the cover unit 5 mounted on the base unit 2.

The cover unit 5 is fixed on the base unit 2 by an attachment, for example, hooks 8 formed at the cover unit 5 and eyes 9 at the base unit 2. The cover unit 5 is detached from the base unit 2 by a user according to a predetermined procedure provided by a manufacture of the notebook computer 10. Namely, the attachment is designed by the manufacture so that the user exchanges the cover unit 5 easily.

Plastic, synthetic resins, rubber and so on can apply to raw material for the cover unit 5.

In case that a pointing device is placed on the base unit 2 in front of the keyboard 3, an opening, which the pointing device exposes from, is formed on the cover unit 5, or the cover unit 5 is comprised of plural parts in order to expose the device.

The user purchases the cover unit 5 of a favorite color or paints the cover unit 5 so that individuality of the user can be reflected on the notebook computer 10. Means for reflecting individuality of the user may include drawing a picture or carving on the cover unit 5.

By reflecting individuality of the user on the cover unit 5 in such a manner, when the user views the front of the notebook computer 10, the user can distinguish his/her notebook computer 10 in an open state of the display unit 1, such as in a case of use of the notebook computer.

In addition, in the notebook computer 10 of this embodiment, the cover unit 5 is exposed at the front surface and the lower surface of the base unit 2. Therefore, in a closed state of the display unit 1 over the base unit 2, the user can reflect his/her individuality on the notebook computer. Moreover, the user can distinguish his/her notebook computer 10 from another.

Furthermore, since the user lays a palm on the palm rest 4 during operation of the keyboard, an egregious deterioration occurs in the palm rest 4, such as dirt and discoloring. When the palm rest 4 is deteriorated, the cover unit 5 is exchanged based on preference of the user, and the user obtains a new palm rest 4. If the user possesses plural kinds of the cover unit 5, the user can select the cover unit 5 of a kind matching with feeling of the user day by day.

As described above, the notebook computer 10 of the first embodiment according to the present invention is characterized in that the user can select the cover unit 5 in accordance with preference to reflect individuality of the user on the notebook computer, and that the palm rest 4 is formed on the cover unit 5, in which a comparatively egregious deterioration occurs.

From a point of view of users, therefore, the present invention has an excellent effect that the cover unit 5 is exchanged on preference of the users, while the palm rest 4 is changed to new one because of deterioration.

On the other hand, from a point of view of a manufacturer of the notebook computer 10, the present invention gives a user not only an incentive to exchange the cover unit 5 on preference, but also an incentive to exchange the cover unit 5 for new one for renewal of the deteriorated palm rest 4, thus leading to a promotion of the cover unit 5. Accordingly, it is understood that the present invention leads to a promotion of such notebook computer 10.

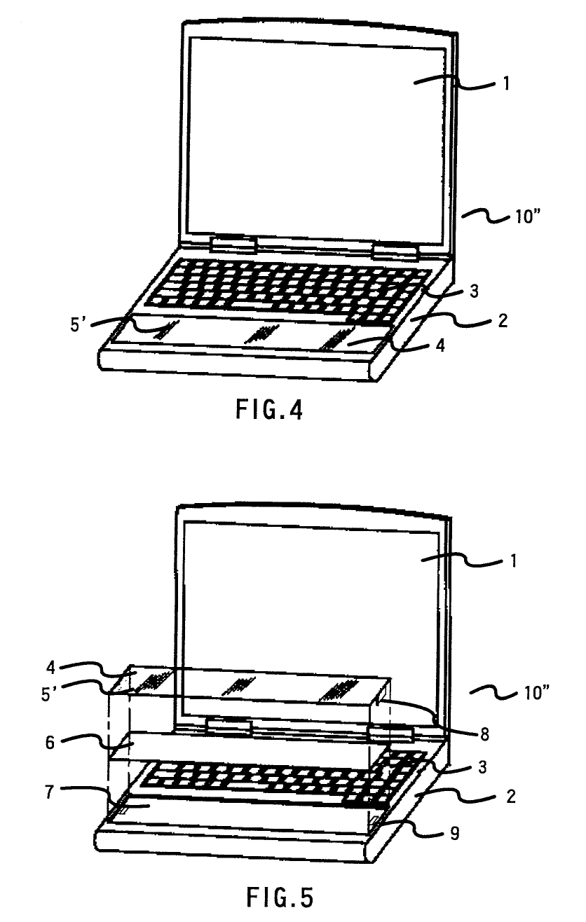

In the first embodiment described above, the cover unit 5 may be formed to cover a side surface of the base unit 2. In this case, a user can distinguish his/her notebook computer from another on viewing the side surface of the notebook computer. As shown in the notebook computer 10″ in FIG. 4, the cover unit 5′ may be formed so as to cover only an area corresponding to the palm rest 4.

Description will next be made on the notebook computer of a second embodiment according to the present invention.

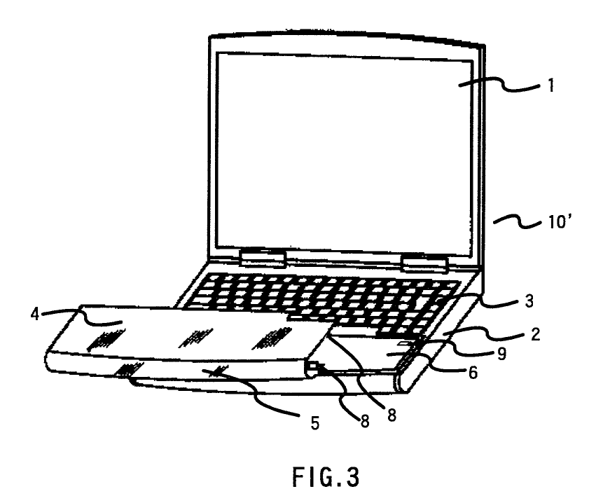

Referring to FIG. 3, in the notebook computer 10′ of the second embodiment according to the present invention, the cover unit 5 is composed of a transparent member. The base unit 2 is formed such that a space is created at a predetermined position between the cover unit 5 and the base unit 2 for insertion of a decorative sheet 6.

When the user exchanges the decorative sheet 6 for another one, by an attachment according to a predetermined procedure provided by a manufacture of the notebook computer 10′, the user detaches the cover unit 5 from the base unit 2, exchanges the decorative sheet 6 for another one, and fixes the cover unit 5 on the base unit 2.

A space may be provided such that the decorative sheet 6 can be freely inserted into and pulled out from the space even in a state where the cover unit 5 is fitted onto the base unit 2 as shown in FIG. 1.

The decorative sheet 6 may be a colored film or a sheet formed by printing a picture freely drawn by a user, for example. A material and a design desired by a user may be used for the decorative sheet 6 and are not particularly limited. As a matter of course, a memorandum or the like may be inserted into the space.

As described above, individuality of a user is reflected on the decorative sheet 6, which is visible transparently through the cover unit 5. Thus, the user can distinguish his/her notebook computer from another on viewing the front of the notebook computer in the open state of the display unit 1, such as a state in use.

In the notebook computer of this embodiment, the cover unit 5 is exposed at the front surface and the lower surface of the base unit 2, and the decorative sheet 6 is disposed at the exposed portion. Consequently, a user can reflect individuality on the notebook computer in the closed state of the display unit 1 over the base unit 2. Moreover, the user can distinguish his/her notebook computer from another.

In this embodiment, the cover unit 5 may be formed so as to cover the side surface of the base unit 2, and the decorative sheet 6 may be disposed at the side surface. Consequently, the user can distinguish his/her notebook computer from another on viewing the side surface thereof.

In this embodiment, as shown in FIG. 4, the cover unit 5′ may be formed so as to cover only an area corresponding to the palm rest 4. Preferably, in this case, with reference to FIG. 5, a space 7 is provided on the base unit 2, in which the decorative sheet 6 and the cover unit 5′ are fitted.

It is understood that the present invention can be applied to a keyboard on which a palm rest is mountable.

While this invention has been described in conjunction with the preferred embodiment described above, it will now be possible for those skilled in the art to put this invention into practice in various other manners.

What is claimed is:

1. An information processing apparatus which includes a base unit having a keyboard and a palm rest on an upper surface, and a display unit coupled to said base unit to be opened and closed with respect to said base unit, comprising:
a cover unit which covers at least a portion of said base unit to form said palm rest and being attachably and detachably mounted on said base unit.

2. The information processing apparatus according to claim 1, wherein said cover unit is mounted on said base unit to sandwich a part of the upper surface and a part of a lower surface of said base unit from a front surface of said base unit.

3. The information processing apparatus according to claim 1, wherein said cover unit is formed to cover only a part of upper surface of said base unit.

4. The information processing apparatus according to claim 1, wherein said cover unit is formed to cover only an area corresponding to said palm rest.

5. The information processing apparatus according to claim 1, wherein said cover unit is formed of a transparent member, and a space, on which a decorative sheet is located, is provided between said cover unit and said base unit.

6. The information processing apparatus according to claim 5, wherein said space is formed as said decorative sheet is freely inserted and pulled out in a state where said cover unit is fitted onto said base unit.

7. The information processing apparatus according to claim 1, wherein said cover unit is detached from and mounted onto the base unit by a user according to a predetermined procedure provided by a manufacture of said information processing apparatus.

8. An information processing apparatus which includes a base unit having a keyboard and a palm rest on an upper surface, and a display unit coupled to said base unit to be opened and closed with respect to said base unit, comprising:
a cover unit which covers at least a portion of said base unit to form said palm rest and being attachably and detachably mounted on said base unit, and
an attachment for attaching said cover unit to said base unit and detaching said cover unit from said base unit.

9. The information processing apparatus according to claim 8, wherein said attachment is designed by a manufacture of said notebook computer on the assumption that a user exchanges said cover unit.

10. The information processing apparatus according to claim 8, wherein said cover unit is detached from and mounted onto the base unit by a user according to a predetermined procedure provided by a manufacture of said information processing apparatus.

11. The information processing apparatus according to claim 8, wherein said cover unit is mounted on said base unit to sandwich a part of the upper surface and a part of a lower surface of said base unit from a front surface of said base unit.

12. The information processing apparatus according to claim 8, wherein said cover unit is formed to cover only a part of upper surface of said base unit.

13. The information processing apparatus according to claim 8, wherein said cover unit is formed to cover only an area corresponding to said palm rest.

14. The information processing apparatus according to claim 8, wherein said cover unit is formed of a transparent member, and a space, on which a decorative sheet is located, is provided between said cover unit and said base unit.

15. The information processing apparatus according to claim 14, wherein said space is formed as said decorative sheet is freely inserted and pulled out in a state where said cover unit is fitted onto said base unit.
